(19) United States
(12) Patent Application Publication
(10) Pub. No.: US 2023/0050163 A1
(43) Pub. Date: Feb. 16, 2023

(54) APPARATUSES AND METHODS FOR SCHEDULING COMPUTING RESOURCES

(71) Applicant: HUAWEI CLOUD COMPUTING TECHNOLOGIES CO., LTD., Gui Zhou Province (CN)

(72) Inventors: Zhenhua HU, Toronto (CA); Lei GUO, Markham (CA); Xiaodi KE, Markham (CA); Cong GUO, Kanata (CA); Siqi JI, Shenzhen (CN); Lei ZHU, Shenzhen (CN); Jianbin ZHANG, Shenzhen (CN)

(73) Assignee: HUAWEI CLOUD COMPUTING TECHNOLOGIES CO., LTD., Gui Zhou Province (CN)

(21) Appl. No.: 17/902,038

(22) Filed: Sep. 2, 2022

Related U.S. Application Data
(63) Continuation of application No. PCT/CN2021/112868, filed on Aug. 16, 2021.

(51) Int. Cl. G06F 9/48; G06F 9/50

(52) U.S. Cl. CPC G06F 9/4881; G06F 9/505; G06F 9/5077

(57) ABSTRACT

Apparatus and methods for scheduling computing resources is disclosed that facilitate the cooperation of resource managers in the resource layer and workload schedulers in the workload layer working together so that resource managers can efficiently manage and schedule resources for horizontally and vertically scaling resources on physical hosts shared among workload schedulers to run workloads.

### CROSS-REFERENCE APPLICATIONS

The present application is the first application for this disclosure.

### TECHNICAL FIELD

The present disclosure relates to apparatuses and methods for scheduling computing resources and in particular to systems and methods for cooperative scheduling of computing resources in cloud computing.

### BACKGROUND

In cloud computing, a cluster of connected physical hosts is managed by a resource scheduler and shared by multiple workload schedulers to run different workloads of applications and services for tenants and users.

The resource scheduler schedules resource requests to allocate resources on physical hosts as requested by the workload schedulers. Some examples of resource schedulers include YARN Resource Managers, Mesos, OpenStack Scheduler, and Kubernetes™ Scheduler.

On behalf of users and applications, workload schedulers schedule workloads to run jobs/tasks and services on resources allocated by the resource scheduler. Some examples of workload schedulers include YARN AppMaster, Spark, Apache Aurora, OpenStack Conductor, Kubernetes™ Controller.

One problem with the current arrangement is that the workload layer does not know what resources are available from the resource layer and the resource layer does not have a means for planning and scheduling those resources.

Another problem is sporadic, frequent and unplanned interactions between the workload scheduler and the resource scheduler, causing a slowdown of performance, and fragmenting of resources.

Yet another problem is how to efficiently and cooperatively schedule physical resources for virtual machines (VMs) and hypervisor-based container workloads.

### SUMMARY

What is needed, then, are apparatus and methods for cooperative scheduling of computing resources in cloud computing that will allow the resource layer and the workload layer to work together efficiently and cooperatively to manage and schedule resources for horizontally and vertically scaling workloads on shared physical hosts.

Accordingly, then, in a first aspect, there is provided a method for scheduling computing resources, the method comprising: submitting a resource allocation plan by a workload scheduler to a resource scheduler; allocating by the resource scheduler a first resource allocation of first resources in accordance with the resource allocation plan and notifying the workload scheduler of the first resource allocation; running workloads of the workload scheduler on the first resources by the workload scheduler; allocating by the resource scheduler a second resource allocation of second resources in accordance with the resource allocation plan and notifying the workload scheduler of the second resource allocation; and running the workloads of the workload scheduler on the second resources by the workload scheduler.

In one implementation of the first aspect, the resource allocation plan includes at least one allocation plan attribute chosen from a group of attributes consisting of allocation specifications, allocation goals, scheduling hints, and time constraints.

In another implementation of the first aspect, wherein the resource allocation plan includes a request for fusible resources, the method further includes fusing by the resource scheduler at least a portion of the first resource allocation with at least a portion of the second resource allocation.

In another implementation of the first aspect the method includes releasing at least a portion of the first resource allocation or at least a portion of the second resource allocation by the workload scheduler back to the resource scheduler when the at least a portion of the first resource allocation or the at least a portion of the second resource allocation is no longer required to run the workloads of the workload scheduler.

In another implementation of the first aspect the method further includes offering by the resource scheduler to the workload scheduler a third resource allocation when the resource allocation plan has not been completed and the resource scheduler has additional resources to allocate in accordance with the resource allocation plan. In this implementation, when the resource allocation plan includes a request for fusible resources, the method may further include acceptance of the third resource allocation by the workload scheduler; and fusing by the resource scheduler at least a portion of the third resource allocation with at least a portion of the first resource allocation or at least a portion the second resource allocation.

In another implementation of the first aspect, the method includes modifying the resource allocation plan by the workload scheduler or submitting a new resource allocation plan by the workload scheduler to the resource scheduler.

In another implementation of the first aspect, the workload scheduler is a first workload scheduler and the resource allocation plan is a first resource allocation plan, the method further including submitting a second resource allocation plan by a second workload scheduler to the resource scheduler to run workloads of the second workload scheduler.

In accordance with a second aspect, there is provided an apparatus comprising: a workload scheduler comprising a processor having programmed instructions to prepare and submit a resource allocation plan to a resource scheduler; the resource scheduler comprising a processor having programmed instructions to receive the resource allocation plan from the workload scheduler and allocate a first resource allocation of first resources in accordance with the resource allocation plan and to notify the workload scheduler of the first resources; the processor of the workload scheduler is configured to run workloads of the workload scheduler on the first resources; the processor of the resource scheduler is configured to allocate a second resource allocation of second resources in accordance with the resource allocation plan and notify the workload scheduler of the second resources; and the processor of the workload scheduler is configured to run the workloads of the workload scheduler on the second resources.

In accordance with one embodiment of the second aspect, the resource allocation plan includes at least one allocation plan attribute chosen from a group of attributes consisting of allocation specifications, allocation goals, scheduling hints, and time constraints.

In accordance with another embodiment of the second aspect, when the resource allocation plan includes a request for fusible resources, the processor of the resource scheduler is configured to fuse at least a portion of the first resource allocation with at least a portion of the second resource allocation.

In accordance with another embodiment of the second aspect, the processor of the workload scheduler is configured to release at least a portion of the first resource allocation or at least a portion of the second resource allocation back to the resource scheduler when the at least a portion of the first resource allocation or the at least a portion of the second resource allocation is no longer required to run the workloads of the workload scheduler.

In accordance with another embodiment of the second aspect, the processor of the resource scheduler is configured to offer to the workload scheduler a third resource allocation when the resource allocation plan has not been completed and the resource scheduler has additional resources to allocate in accordance with the resource allocation plan. In this embodiment, when the resource allocation plan includes a requests for fusible resources, the processor of the workload scheduler may be configured to accept the third resource allocation; and the processor of the resource scheduler may be configured to fuse at least a portion of the third resource allocation with at least a portion of the first resource allocation or at least a portion the second resource allocation.

In accordance with another embodiment of the second aspect, the processor of the workload scheduler is configured to modify the resource allocation plan or submit a new resource allocation plan to the resource scheduler.

In accordance with another embodiment of the second aspect, the workload scheduler is a first workload scheduler and the resource allocation plan is a first resource allocation plan, the apparatus further includes a second workload scheduler comprising a processor having programmed instructions to prepare and submit a second resource allocation plan to the resource scheduler to run workloads of the second workload scheduler.

In accordance with a third aspect there is provided a computer program comprising instructions which, when the program is executed by a computer, cause the computer to carry out the above-mentioned methods.

In accordance with a fourth aspect there is provided computer-readable medium comprising instructions which, when executed by a computer, cause the computer to carry out the above-mentioned methods.

By having the workload schedulers submit resource allocation plans to the resource scheduler, the plans including specific allocation plan attributes for the resources being requested and by having the resource scheduler allocate resources to the workload scheduler in accordance with the plans, performance and fragmentation problems caused by sporadic, frequent and unplanned interactions between the workload scheduler and the resource scheduler can be mitigated. The workload schedulers make requests to the resource scheduler for multiple resource allocations in one or multiple plans, receive resource allocations with much better predictivity derived from the plans, continue using the resource allocations to run different workloads, and release all or fractions of the resource allocations if the resources allocations are no longer needed. The resource scheduler may schedule and return a first resource allocation to a workload scheduler, continuously schedule and return more resource allocations to the workload scheduler interactively and offer new resource allocations to be fused to the existing resource allocations of the workload scheduler on the physical hosts as requested by the workload scheduler.

### BRIEF DESCRIPTION OF THE DRAWINGS

The present disclosure will be better understood with reference to the drawings, in which:

FIG. 1 is a schematic view showing the interaction between the workload layer and the resource layer in accordance with the embodiments of the present disclosure.

FIG. 2 is a flow chart illustrating the cooperative and interactive scheduling between the workload scheduler and the resource scheduler in accordance with the embodiments of the present disclosure.

FIGS. 3A to 3E are schematic diagrams showing one example of cooperative scheduling of resources in accordance with the embodiments of the present disclosure.

FIGS. 4A to 4C are schematic diagrams showing another example of cooperative scheduling of computing resources in accordance with the embodiments of the present disclosure.

FIG. 5 is a block diagram illustrating a computing platform in accordance with the embodiments of the present disclosure.

### DETAILED DESCRIPTION

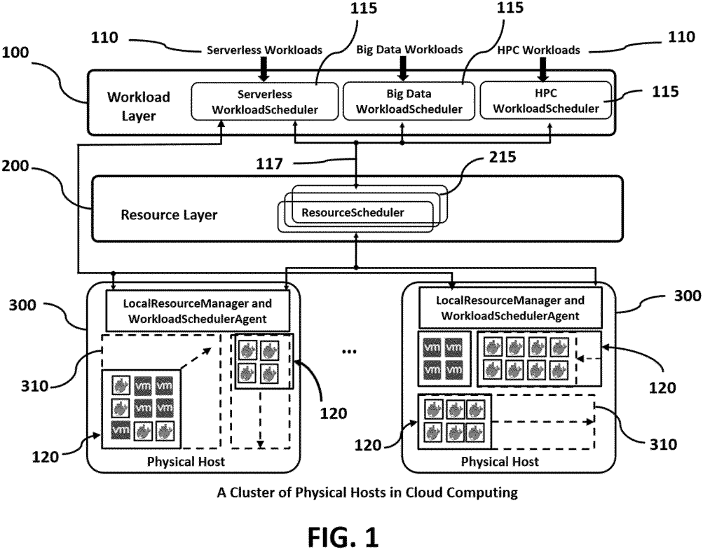

Referring to FIG. 1, the basic concept of the cooperative scheduling of computing resources in cloud computing is described. A workload layer 100 may include several different types of workloads 110 including applications and services for tenants and users. For example, workloads 110 may include serverless workloads, big data workloads, high-performance computing (HPC) workloads or other types of workloads. Each workload 110 includes a workload scheduler 115 to schedule and run the workloads 110 for the workload scheduler’s tenants and users. A resource layer 200 includes a resource scheduler 215 to schedule resource requests from the workload layer 100 onto physical hosts 300 to run the workloads 110. Both the workload scheduler 115 and the resource scheduler 215 may be implemented as software running on a microprocessor or as dedicated hardware circuits on separate devices.

The workload scheduler 115 sends a resource allocation plan 117 to the resource scheduler 215 requesting resource allocations 120 of computing resources to run workloads 110. The resource allocation plan 117 includes at least one allocation attribute of the computing resources being requested. Allocation attributes may be one or more of allocation specifications, allocation goals, scheduling hints, and/or time constraints all of which are further detailed below. One skilled in the art will appreciate that other allocation attributes may be contemplated and included in the resource allocation plan 117. One possible allocation attribute of the resource allocation plan 117 is that the requested resource allocations 120 may be scheduled and fused together as larger resource allocations on the physical hosts 300 to run the workloads 110. Once the resource allocations 120 are no longer required the workload scheduler 115 may release some of the resource allocations, all of the resource allocations, or fractions of the resource allocations back to the resource scheduler 215.

The resource scheduler 215 schedules resources on the physical hosts 300 to satisfy the resource allocation plan 117 based on the various allocation specifications, allocation goals, scheduling hints, and/or time constraints. Resource allocations 120 are fusible if they can be combined and used as a single resource, for example, if they are scheduled on the same physical host 300. If fusible resources are requested in the resource allocation plan 117 and allocated by the resource scheduler 215, on the same physical host 300, small resource allocations 120 may be fused together into larger fused resource allocations 120. A fused resource allocation 120 may be incrementally scheduled from a small resource allocation 120 to as large as the entire physical host 300 as long as resources are available. The resource scheduler 215 performs continuous scheduling to satisfy the resource allocation plan 117. Additional resource allocations 120 can be offered to or requested by the workload scheduler 115. A fused resource allocation on physical host 300 which includes the resource allocations 120 of the same workload scheduler 115 is referred to as an elastic logic host 310 for that workload scheduler 115 on the physical host 300.

Once resource allocations 120 are scheduled on physical host 300, the workload scheduler 115 can schedule and run any size of workload 110 that will fit on the resource allocation 120. It can use and reuse the resource allocation to launch VMs and hypervisor-based containers, as well as jobs and tasks inside the VMs and hypervisor-based containers, directly on the resource allocation 120 through a local resource manager and local workload-scheduler-specific runtime agents located on the physical host 300. The local resource manager can have a built-in hypervisor-based runtime agent to launch VMs and hypervisor-based containers on physical host 300.

The local resource manager and the local workload scheduler runtime agent on physical host 300 execute and monitor the VM and container workloads, optimize the workloads by binding and migrating them on the local resources (such as CPU, GPU, memory, NUMA, etc.), making sure that their resource usages will not go beyond the resource allocations 120 for the workload scheduler 115 on physical host 300, and that the total usages will not go beyond the physical host resource capacity.

The local resource manager on every physical host 300 communicates with the resource scheduler 215 concerning heartbeat and resource allocation information. Heartbeat provides information on the host’s status and/or availability.

As noted above, the resource allocation plan 117 may be specified by allocation attributes comprising one or more of at least four types of data: allocation specifications, allocation goals, scheduling hints, and/or time constraints.

Allocation specifications is a multi-dimensional data set of resource allocation specifications specifying the flavor and multi-dimensional size of qualitative resources expected by the workload scheduler 115 for the resource allocation plan 117. A tuple of (X CPU cores, X GB of memory, CPU model) is an example of flavor and size of the multi-dimensional resource specification, where CPU cores and GB of memory are quantitative resources, CPU model is a qualitative resource property, and X is the size or multi-dimensional number of the qualitative resource required. One example of a resource allocation specification tuple is (4 CPU cores, 32 GB memory, Intel i7). Allocation specifications may include a minimum allocation to specify a minimum requirement for the quantitative resource and a maximum allocation to specify a maximum requirement for the quantitative resource. Allocation specifications may also include steps to specify an acceptable increment between the minimum allocation and the maximum allocation. For example, minimum allocation = (1, 2); maximum allocation = (16, 32) and steps = 2, would specify a minimum allocation size for each resource of 1 CPU core and 2 GB of memory, a maximum allocation size of 16 CPU cores and 32 GB of memory and would further specify that the allocation may be incremented in “times 2 per step”. In this case acceptable resource allocation sizes are - (1, 2), (2, 4), (4, 8), (8, 16) and (16, 32). Any other allocation size such as (5, 10) or (32, 64) is not acceptable. Allocation specifications for the resource allocation plan 117 may include one or more consumer arrays or consumer sets. Elements in consumer arrays have the same specifications of allocation flavor (CPU cores and GB of memory) and proportional sizes. For example, elements for CPU cores and GB of memory of sizes (1, 2), (2, 4), (4, 8), (8, 16) and (16, 32) may be put in one consumer array because the larger elements can be managed as fused multiples of the small elements; whereas elements in a consumer set may have different specifications for elements that are not proportional in size [for example (1, 3), (2, 5), and (6, 9)].

Allocation goals specify goals for scheduling of the resource allocation plan 117 or any consumer array or consumer set sub-levels under the resource allocation plan 117. Allocation goals can specify minimum total, maximum total, allocation quality goal, or allocation cost goals. Minimum total and maximum total are the minimum and maximum capacities of the total resource allocation in the resource allocation plan 117. Allocation quality goal is a measurement of the resource allocation quality needed to meet the minimum total and maximum total goals. Allocation quality goals may include a preference for allocation size, number of allocations, size of unusable small resource fragments, affinity, proximity, and availability. Allocation cost goal is a measurement of the total cost of the resources required to meet minimum total and maximum total. For example, if the cost of the minimum total of resources requested by the workload scheduler 115 exceeds the allocation cost goal, no resources are scheduled by the resource scheduler 215 for the resource allocation plan 117.

Scheduling hints include priority, limits, affinity or fusibility. Priority is used to determine the order in which resource allocation plans 117, consumer arrays and consumer sets should be scheduled. Limits including limit per host or limit per availability zone are used to limit the number of resource allocations or the number of resources that are to be scheduled per physical host or per availability zone. Affinity may include allocation affinity which is used to indicate that resource allocations are to be scheduled close to each other for better performance (for example, to reduce network hops); and allocation anti-affinity which is used to indicate that resource allocations should be scheduled distant from each other for high availability (for example, if one physical host or availability zone stops working, only a small portion of the allocated resources will be affected). Affinity can be applied within the resource allocation plan 117, consumer array or consumer set or across multiple resource allocation plans 117, consumer arrays or consumer sets. If anti-affinity is requested between two resource allocations 120, they will not be scheduled as fusible resource allocations by the resource scheduler 215 . Otherwise, the resource allocations 120 may be scheduled as fusible resource allocations. Fusibility may include fuse factors which define how to fuse multiple resource allocations 120, which could include a list of sizes or numbers of fused resource allocations, where a special value “fuse to any size” means the fused resulting allocation can be any size.

For example, in cloud computing a master-worker application includes application masters that work as workload schedulers, manage and coordinate application workers to run workloads. The application workers do the actual computations required by workloads. If a master-worker application requires three application masters and a large number of application workers, resource allocations for the three application masters require anti-affinity (that is, non-fusible resource allocations). Allocations for the application workers require affinity (that is, fusible resource allocations). But neither affinity nor anti-affinity is required between the resource allocations for the application masters and the application workers. The resource scheduler 215 will not schedule fusible resource allocations 120 among the application masters since the resource allocation plan 117 requests anti-affinity for these resources. The resource scheduler 215 will attempt to schedule fusible resource allocations 120 among the application workers since the resource allocation plan 117 requests affinity for these resources. However, if the resource scheduler 215 finds resource allocations 120 between an application master and an application worker on the same physical host 300, it will schedule fusible resource allocations 120 and notify the workload scheduler 115 that these resource allocations 120 are fusible. The workload scheduler 115 then has the freedom to fuse the resource allocations into larger resource allocations or use them separately. If anti-affinity is requested between two resource allocations 120 they will not be scheduled as fusible resource allocations by the resource scheduler 215. Otherwise, the resource allocations 120 may be scheduled as fusible resource allocations.

Time constraints include preferred times to meet the resource allocation plan 117 and may include the time to meet the minimum total, time to meet the maximum total and time windows to indicate what time windows or ranges may be applied and whether the time window is periodic or one-off, or if the time window may be considered in conjunction with other resource allocation plans 117.

Resource allocation plans 117 may have multiple levels of allocation attributes. For example, a resource allocation plan 117 may contain a number consumer arrays and/or consumer sets and have two levels of allocation attributes, one at the consumer array/consumer set level and another at the resource allocation plan 117 level. The allocation attributes of allocation specifications, allocation goals, scheduling hints, and/or time constraints may be specified at the consumer array/consumer set level as well as the resource allocation plan 117 level.

Consumer array / consumer set level allocation attributes may include the allocation specifications of a base allocation, which is a multi-dimensional allocation requirement of flavor and sizes of the array elements; allocation goals of minimum total and maximum total of the total array sizes; scheduling hints of this array and with other arrays; and time constraints.

Resource allocation plan 117 level allocation attributes may include the allocation goals of minimum total and maximum total at the resource allocation plan 117 level which are calculated and converted from consumer array/consumer set level allocation goals of all of its consumer arrays/consumer sets; scheduling hints can be applied at the resource allocation plan 117 level, at the consumer array/consumer set level, across all of its consumer arrays/consumer sets, or across multiple resource allocation plans 117; and time constraints can be applied at the resource allocation plan 117 level, at the consumer array/consumer set level, across all of its consumer arrays/consumer sets, or across multiple resource allocation plans 117.

Allocation specifications may also be specified by multi-allocations that is a list of 4-tuples, each 4-tuple is <allocation specification, minimum subtotal, maximum subtotal, preference>. Allocation specification is a multi-dimensional allocation requirement of flavor and sizes; Minimum subtotal is the minimal number of this allocation specification required; maximum subtotal is the maximal number of this allocation specification required; preference is a preference number of this allocation specification relative to the other 4-tuples in the list of multi-allocations, with the higher number being the more preferred.

Benefits of the above-disclosed exemplary implementations include: (1) by having the workload schedulers 115 submit resource allocation plans 117 to the resource scheduler 215, the plans including specific allocation plan attributes for the resources being requested, and having the resource scheduler 215 allocate computing resources to the workload schedulers 115 in accordance with the resource allocation plans 117, the performance and fragmentation problems caused by sporadic, frequent and unplanned interactions between the workload scheduler 115 and the resource scheduler 215 are mitigated; (2) the workload scheduler 115 can make a request to the resource scheduler 215 for multiple resource allocations 120 in one or multiple resource allocation plans 117, receive resource allocations 120 with much better predictivity derived from the resource allocation plans 117, continue using its existing resource allocations 120 to run different workloads 110, and partially release fractions of the resource allocations 120 if they are no longer needed; and (3) the resource scheduler 215 may schedule and return a first resource allocation 120 to the workload scheduler 115, continuously schedule and return more resource allocations 120 to the workload scheduler 115 interactively, and offer new resource allocations 120 to be fused to the existing resource allocations 120 of the workload scheduler 115 on the physical hosts 300 as requested by the workload scheduler 115.

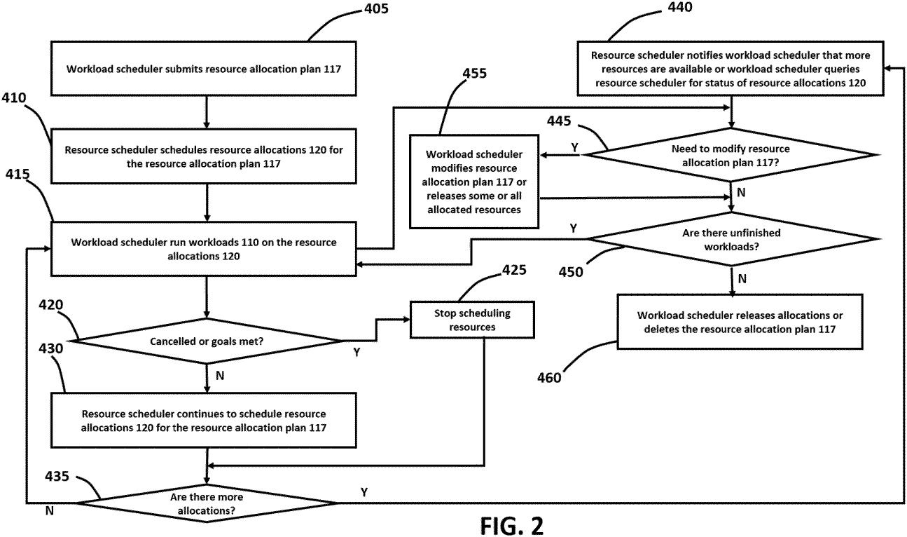

Referring to FIG. 2, the method for cooperative scheduling of computing resources in cloud computing is shown in schematic form. In step 405 the workload scheduler 115 submits resource allocation plan 117 to the resource scheduler 215. In one example, the resource allocation plan 117 may include the following allocation attributes:
allocation specifications = (minimum allocation, steps, maximum allocation)
allocation goals = (minimum total, maximum total, allocation quality goals, allocation cost goals)
scheduling hints = (allocation affinity, fuse factors)
time constraints = (time to meet minimum total, time to meet maximum total, time windows)

In step 410 the resource scheduler 215 schedules resources allocations 120 for the resource allocation plan 117 by searching for resources based on the allocation specifications = (minimum allocation, steps, maximum allocation) to reach the allocation goals with high quality resource allocations 120 that meet the allocation goals of quality and cost for the minimum and maximum total of resource allocations based on the scheduling hints. Once the resource scheduler 215 finds enough resources to make the requested allocations to meet the minimum total, resource scheduler 215 returns the allocation to workload scheduler 115 at step 415 so that workload scheduler 115 can start using the allocation of the resource to schedule and run its workloads through the local resource manager and workload scheduler agent. If the time to meet minimum total expires before the minimum total is met, resource scheduler 215 returns zero allocations to workload scheduler 115 for the resource allocation plan 117. In this case, minimum total may be treated as a type of gang-scheduling request where if the resulting allocation 120 is not greater than or equal to minimum total of resources requested, zero allocations are returned to the workload scheduler 115. Once the minimum total is met or the time to meet the minimum total expires, the workload scheduler 115 may cancel further scheduling of the resource allocation plan 117.

At step 420, if resource allocation plan 117 is cancelled, or if time to meet the maximum total has expired, or if the maximum total has been met, then resource scheduler 215 stops scheduling more resources for the resource allocation plan 117, step 425, and checks at step 435 if it has more resource allocations for the resource allocation plan 117. If there are no more resources to allocate the workload scheduler 115 continues using the allocations to schedule and run its workloads through the local resource manager and the workload scheduler agent, step 415.

At step 435, if resource scheduler 215 has more resources to allocate it can notify the workload scheduler 115 of the new resource allocation offers at step 440 or the workload scheduler 115 may query the resource scheduler 215 to find out the status of resource allocations. If the offers are acceptable, workload scheduler 115 accepts the offers and runs more workloads on the newly scheduled allocations 120. If the resource allocation plan 117 includes a request for fusible resources, the workload scheduler 115 may fuse the new resource allocations with its existing resource allocations 120. In addition, if workload scheduler 115 requires more fusible resources to run its workloads, workload scheduler 115 may send a request to resource scheduler 215 for new allocations by modifying the resource allocation plan 117 or submit a new resource allocation plan 117.

At step 420 if resource allocation plan 117 is not cancelled, and if the time to meet maximum total has not expired, and if maximum total has not been met, resource scheduler 215 performs continuous scheduling and optimization at step 430 by searching for more local-host and cross-host resource allocations 120 within the time constraints and optimizes the resource allocations 120 for the resource allocation plan 117 to reach the allocation goals with high quality resource allocations specified by the allocation quality goals and the allocation cost goals to meet minimum total (if it is not met yet) and maximum total.

During continuous scheduling at step 430, resource scheduler 215 performs the following steps until the allocation goals are reached and maximum total is met; or workload scheduler 115 tells resource scheduler 215 to stop the continuous scheduling; or time to meet maximum total is expired:
(1) Searches for more resource allocations in accordance with the resource allocation plan 117.
(2) If there are resources freed up on a physical host 300, then schedule new allocations for the resource allocation plan 117 and if the resource allocation plan 117 includes a request for fusible resources schedule the freed up resources as fusible resource allocations which can be fused into existing resource allocations on the same physical host 300 to make large resource allocations based on fuse factors specified in the resource allocation plan 117.
(3) Offer cross-host fusion of resource allocations 120 to move or swap a resource allocation from one physical host to fuse into another resource allocation on another physical host based on fuse factors specified in the resource allocation plan 117. The actual movement of the resource allocations 120 can be done by VM/container vertical scaling or migration, or in a manner similar to rolling blue-green deployment via restart or recreation. This procedure can incrementally schedule and fuse larger and larger resource allocations 120 for workload scheduler 115 and improve application affinity by fusing many resource allocations 120 from different physical hosts 300 into a large allocation on the same physical host.

At step 445, workload scheduler 115 determines if the resource allocation plan 117 needs to be modified or if unused resource allocations 120 or fractions of resource allocations can be released back to the resource scheduler 215. If no modifications or releases are required workload scheduler 115 checks for unfinished workloads 110, step 450. If there are unfinished workloads, workload scheduler 115 continues to run the workloads on the resource allocations received from resource scheduler 215, step 415. If workload scheduler 115 determines that modifications to the resource allocation plan 117 are required or there are resource allocations that can be released, workload scheduler 115 modifies the resource allocation plan 117 or releases the allocations at step 455 and then returns to step 450 to check for unfinished workloads. If there are no unfinished workloads, workload scheduler 115 releases some or all of the resource allocations 120 to the resource scheduler 215 or cancels the resource allocation plan 117, step 460.

In the steps described above, resource scheduler 215 respects the scheduling hints - allocation affinity and allocation anti-affinity - among allocations 120 within the resource allocation plan 117, consumer array or consumer set, or across multiple resource allocation plans 117, consumer arrays or consumer sets. This means that the resource scheduler 215 will try to schedule fusible resource allocations 120 if allocation anti-affinity is not requested for these resource allocations. If allocation anti-affinity is requested for these resource allocations, the resource scheduler 215 will not schedule fusible resource allocations .

Multiple workload schedulers 115 may submit multiple resource allocation plans 117 so that multiple resource allocation plans 117 may be running concurrently on the same resource scheduler 215.

The workload scheduler 115 and resource scheduler 215 run in parallel and independent of one another.

The local resource manager and the local workload scheduler agent optimize the workloads by binding and migrating them on the local resources (such as CPU, GPU, memory, NUMA, etc.).

### Example #1

Referring again to FIG. 2, the following is one practical example of cooperative scheduling of computing resources as herein disclosed.

First, at step 405, workload scheduler 115 submits resource allocation plan 117 to resource scheduler 215 for multiple fusible resource allocations 120 and elastic logic hosts 310. In this example the resource allocation plan 117 may include the following allocation attributes:
allocation specifications = [minimum allocation = (1 CPU core, 2 GB memory), maximum allocation = (16 CPU cores, 32 GB memory), steps = “times 2 per step”]
allocation goals = [minimum total = (16 CPU cores, 32 GB memory), maximum total = (10240 CPU cores, 20480 GB memory),]
scheduling hints = [(allocation affinity, fuse factor = fuse to any size)
time constraints = [(time to meet minimum total, time to meet maximum total, time windows)]
All resource allocations in the resource allocation plan 117 share the same allocation attributes. As discussed above, those skilled in the art will appreciate that other allocation attributes may be specified in the resource allocation plan 117. For example, allocation goals may include resource allocation cost goals to meet the minimum total and maximum total of resources requested.

In the traditional method of fulfilling the allocation of computing resources, workload scheduler 115 would submit a separate request to resource scheduler 215 for each resource allocation required. The request did not include a resource allocation plan specifying allocation attributes. This resulted in the workload scheduler 115 and resource scheduler 215 having to interact at least 640 times to get 640 maximum allocations of 16 CPU Cores and 32 GB memory to meet a minimum total allocation of 10240 CPU cores and 20480 GB memory. In the worst case, workload scheduler 115 and resource scheduler 215 would have to interact 10240 times to get 10240 minimum allocations of 1 CPU and 2 GB memory to meet a maximum total allocation of 10240 CPU cores and 20480 GB memory. A further problem with the traditional method is that workload scheduler 115 could receive resource allocations having intermediate sizes not requested or desired.

In the present method of cooperative scheduling of computing resources as described herein, the workload scheduler 115 requests many resource allocations in one or more resource allocation plans 117. The resource scheduler 215 is then able to allocate the resources close to each other in large elastic logic hosts 310 and perform the resource allocations in batches or mini batches based on the allocation attributes specified in the resource allocation plan(s) 117. This results in many fewer interactions between the workload scheduler 115 and the resource scheduler 215. There will also be less fragmentation of computing resources across the workload and resource layers. Therefore, performance, scalability and efficiency are increased.

For the present method, in this example, at step 410 in FIG. 2 the resource scheduler 215 attempts to schedule one or more resource allocations 120 (some of them may be located on the same physical host) to meet the minimum total of 16 CPU cores and 32 GB memory and returns the allocations to the workload scheduler 115 in accordance with the resource allocation plan 117.

The workload scheduler 115 gets the minimum allocation of 16 CPU cores and 32 GB memory and starts to run container workloads in hypervisor-based containers, step 415.

At step 430, the resource scheduler 215 continues to schedule more resource allocations 120 for resource allocation plan 117 and at step 435 determines whether or not it has more allocations for resource allocation plan 117. Those additional allocations are offered to workload scheduler 115 at step 440 until the decision is made at step 420 that the maximum total allocations is reached.

At step 440, from time to time, the workload scheduler 115 may also query the resource scheduler 215 for more scheduled allocations of resource allocation plan 117 or wait for notifications from the resource scheduler 215. When more allocations are scheduled by the resource scheduler 215 for resource allocation plan 117, the workload scheduler 115 uses them to run more workloads. The workload scheduler 115 can independently schedule its workloads for different projects, user groups, applications, workflows and so on, using various workload scheduling policies to share resource allocations it gets from the resource scheduler 215. At the same time the resource scheduler 215 is only concerned with resource scheduling and policies in the resource layer 200, without having any concern for what is taking place in the workload layer 100. The workload layer and the resource layer are nicely decoupled and work independent of one another.

At steps 445, 450, 455 and 460, when some workloads of hypervisor-based containers are finished, the workload scheduler 115 decides if there are more workloads to run and may decide not to release the resource allocations back to the resource scheduler 215, but instead may decide to reuse them to run more workloads of hypervisor-based containers or to modify the resource allocation plan 117 or workload scheduler 115 may decide to return all or only a fraction of the resource allocations 120 back to the resource scheduler 215.

If some resource allocations 120 are located on the same physical host 300, and the resource allocation plan 117 includes a request for fusible resources, the resource scheduler 215 can schedule fusible resource allocations that can be fused together into a larger allocation for the workload scheduler 115 to run larger workloads. Workload scheduler 115 can also run multiple small workloads within one large resource allocation 120. All resource allocations on a single physical host 300 can be fused together to create elastic logic host 310 for the workload scheduler 115 to use to run any size of workloads as long as the total resource consumption of the workloads does not go beyond the total capacity of the elastic logic host 310.

When the workload scheduler 115 does not need more resources allocated by the resource scheduler 215 even though the maximum total requirement has not been reached, the workload scheduler 115 can tell the resource scheduler 215 to stop allocating more resources, step 425. When the workload scheduler 115 determines that the current allocated resources are more than enough for its needs, it can release some allocated resources back to the resource scheduler 215, step 445, 450, 460. The released resources can be in whole units of allocations, or even fractions of an allocation. When the workload scheduler 115 no longer needs any resources allocated for the resource allocation plan 117, it can release them all back to the resource scheduler 215 as a whole by cancelling the resource allocation plan 117, step 460.

### Example #2

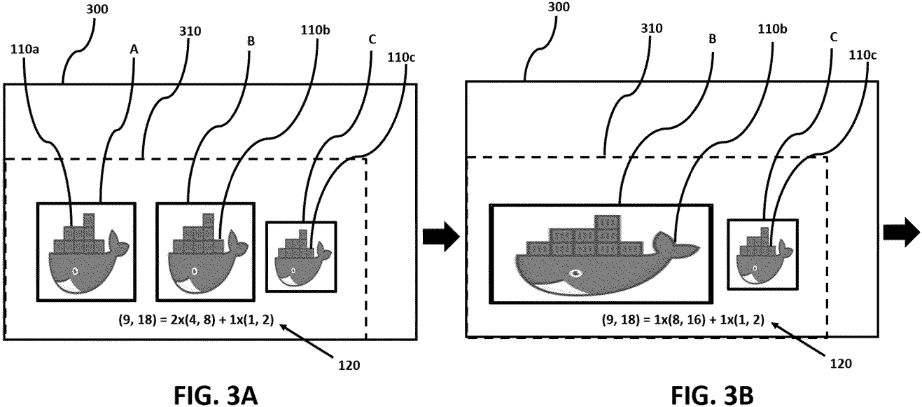

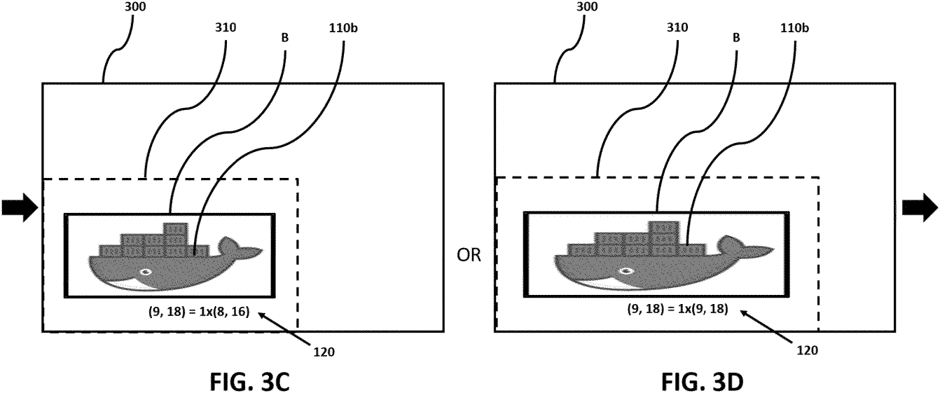

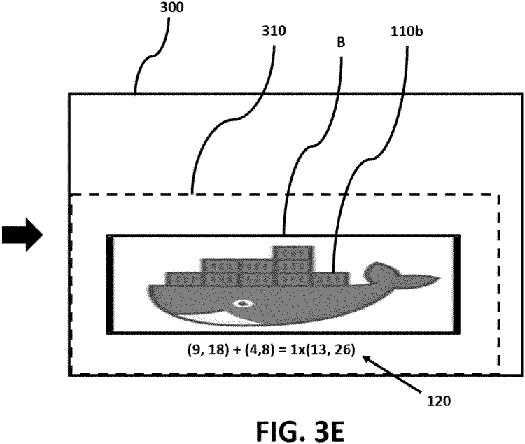

Referring to FIGS. 3A to 3E, the following is another practical example illustrating the advantages of the herein disclosed cooperative scheduling of computing resources. This example assumes the same resource allocation plan 117 and the same allocation attributes used above for Example #1, namely:
allocation specifications = [minimum allocation = (1 CPU core, 2 GB memory), maximum allocation = (16 CPU cores, 32 GB memory), steps = “times 2 per step”]
allocation goals = [minimum total = (16 CPU cores, 32 GB memory), maximum total = (10240 CPU cores, 20480 GB memory),]
scheduling hints = [(allocation affinity, fuse factor = fuse to any size)
time constraints = [(time to meet minimum total, time to meet maximum total, time windows)]
Resource allocations in the resource allocation plan 117 share the same allocation attributes and may include other allocation attributes not specified above.

Workload scheduler 115 submits resource allocation plan 117 to resource scheduler 215. Resource scheduler 215 begins scheduling and allocating the resources and may schedule resource allocations 120 on physical host 300 that already has previous allocations for the workload scheduler 115. Using the local resource manager and its run time agents, workload scheduler 115 may run different sizes of hypervisor-based containers on the same physical host 300 for multiple tenants A, B, C based on their needs. The workload scheduler 115 may reuse its existing allocations to run different workloads without having to release the allocations back to the resource scheduler 215. For example, referring to FIG. 3A, workload scheduler 115 of hypervisor-based container workloads 110a, 110b, 110c has resource allocation 120 of 2 × (4 CPU cores, 8 GB memory) and 1 × (1 CPU core, 2 GB memory) running two (4 CPU cores, 8 GB memory) and one (1 CPU cores, 2 GB memory) hypervisor-based containers on a (9 CPU cores, 18 GB memory) elastic logic host 310 for the three tenants A, B, C, respectively. Each hypervisor-based container is for a different tenant, so that the containers are securely isolated from each other. Referring to FIG. 3B, if workload scheduler 115 no longer needs the first (4 CPU cores, 8 GB memory) hypervisor-based container for tenant A, then the workload scheduler 115 can use the first (4 CPU cores, 8 GB memory) resource allocation of tenant A to run tenant B’s workloads 110b. If the second (4 CPU cores, 8 GB memory) hypervisor-based container for tenant B is resizable (with or without restarting the container), workload scheduler 115 can shut down the first (4 CPU cores, 8 GB memory) hypervisor-based container, and resize the second (4 CPU cores, 8 GB memory) hypervisor-based container to (8 CPU cores, 16 GB memory) for tenant B without releasing the resource allocation 120. When completed, the (9 CPU cores, 18 GB memory) elastic logic host 310 now has one (8 CPU cores, 16 GB memory) and one (1 CPU cores, 2 GB memory) hypervisor-based containers running workloads 110b and 110c for tenants B and C. If there is no need to continue running the third (1 CPU cores, 2 GB memory) hypervisor-based container for tenant C’s workloads 110c, workload scheduler 115 can shut down the third hypervisor-based container and either release the (1 CPU cores, 2 GB memory) back to the resource scheduler 215 (see FIG. 3C) or resize the newly-created (8 CPU cores, 16 GB memory) hypervisor-based container to (9 CPU cores, 18 GB memory) (see FIG. 3D) to run further workloads 110b for tenant B or a new tenant. Either way the (1 CPU cores, 2 GB memory) resource fragment is not wasted.

When additional resource allocations 120 are newly scheduled on physical host 300 for workload scheduler 115, resource scheduler 215 can offer to fuse new allocations with existing allocations on the physical host 300 to create larger elastic logic host 310 for workload scheduler 115 to run larger workloads. Continuing with the previous example and referring to FIG. 3E, the workload scheduler 115 has the fused (9 CPU cores, 18 GB memory) hypervisor-based container for tenant B running on the (9 CPU cores, 18 GB memory) elastic logic host 310. When the resource scheduler 215 schedules and offers to fuse a new (4 CPU cores, 8 GB memory) resource allocation on the physical host 300, workload scheduler 115 may accept the offer and fuse the new (4 CPU cores, 8 GB memory) resource allocation into the existing (9 CPU cores, 18 GB memory) elastic logic host 310 creating a new (13 CPU cores, 26 GB memory) resource allocation 120. Then workload scheduler 115 is able to resize the (9 CPU cores, 18 GB memory) hypervisor-based container to (13 CPU cores, 26 GB memory) for tenant B.

This example can apply to regular VMs as well. However; it may take longer to restart a VM with a different size, and regular VMs are not as easy to resize as hypervisor-based containers.

### Example #3

This example will demonstrate how to make multiple workload schedulers 115 more cloud-native to securely share physical hosts 300 via resource scheduler 215 for multitenant workloads 110 of VMs and hypervisor-based containers through resource allocations 120 on elastic logic hosts 310.

Many current workload scheduling eco-systems (such as batch job scheduling, Big Data workload scheduling, HPC scheduling, Kubernetes workload scheduling) require a concept or object of “hosts” to schedule and run their specific runtime agents and workloads on the “hosts”.

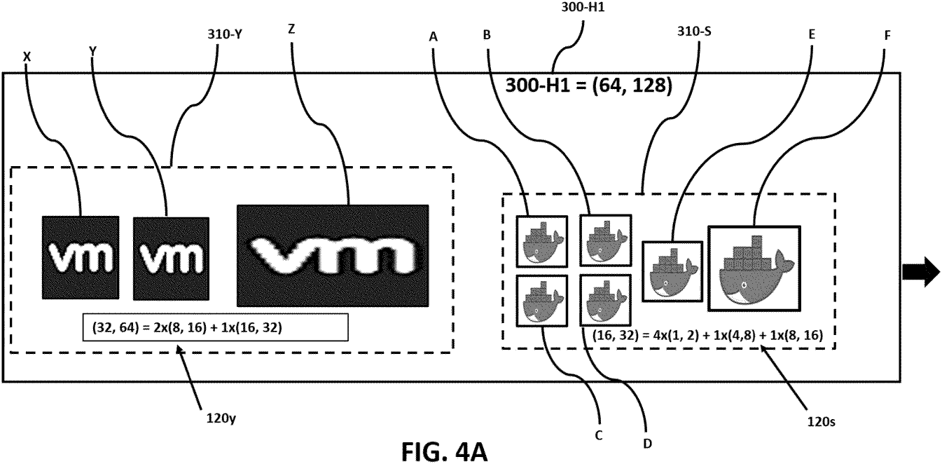

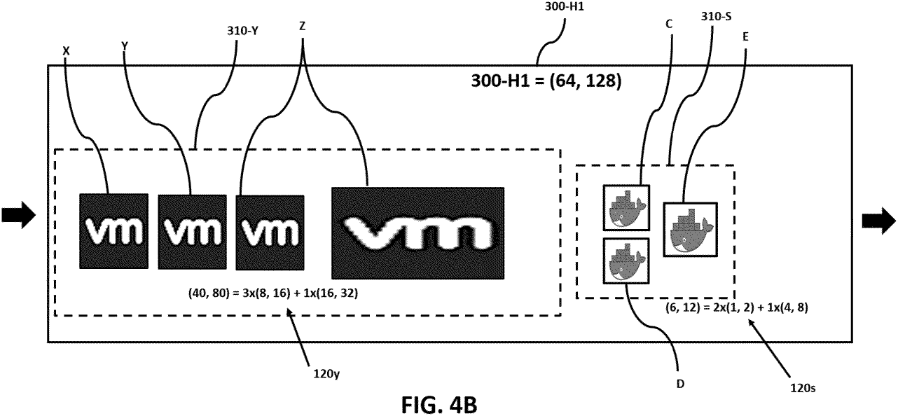

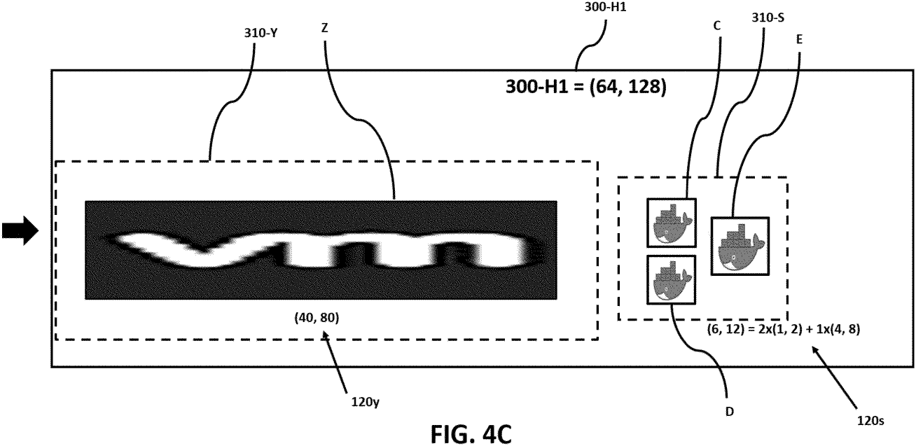

Referring to FIGS. 4A to 4C, there are two workload schedulers 115, one is a YARN workload scheduler using VMs, another is a Spark workload scheduler using hypervisor-based containers (e.g., Kata containers in Lite-VMs). For the purpose of this example, the two workload schedulers 115 may require some modifications to be more cloud native. Both workload schedulers 115 are able to talk to a single resource scheduler 215 that manages a cluster of physical hosts 300-H1, 300-H2, etc. Each physical host has (64, 128) (CPU, GB memory). The YARN Workload scheduler sends the resource scheduler 215 a YARN resource allocation plan 117 for multiple fusible resource allocations 120 having resource allocation attributes of minimum allocation = (8, 16) and maximum allocation = (16, 32), which may be fused into elastic logic host 310-Y to run VMs. The Spark workload scheduler sends the resource scheduler 215 a Spark resource allocation plan 117 to get multiple fusible resource allocations 120 having resource allocation attributes of minimum allocation = (1, 2) and maximum allocation = (8, 16), steps = “times 2 per step” which may be fused into elastic logic host 310-S to run Kata containers in Lite-VMs.

As shown in FIG. 4A, each workload scheduler receives a resource allocation in accordance with its respective resource allocation plan 117. The YARN workload scheduler gets resource allocations 120y of 2 × (8, 16) and 1 × (16, 32), which can be fused together as a (32, 64) elastic logic host 310-Y on physical host 300-H1, and the Spark workload scheduler receives resource allocation 120s of 4 × (1, 2), 1 × (4, 8) and 1 × (8, 16), which can be fused together as a (16, 32) elastic logic host 310-S also on physical host 300-H1.

The YARN workload scheduler schedules and runs one VM of (8, 16) for tenant X, one VM of (8, 16) for tenant Y, one VM of (16, 32) for tenant Z on its elastic logic host 310-Y through the local resource manager and VM runtime agent. Each VM also contains a YARN-specific runtime agent node manager for each tenant X, Y, Z. At the same time, the Spark workload scheduler schedules and runs 4 Kata container Lite-VMs of (1, 2), one Kata container Lite-VM of (4, 8) and one Kata container Lite-VM of (8, 16) for six respective tenants A, B, C, D, E, F on its elastic logic host 310-S through the local resource manager and Kata runtime agent. Each Kata container Lite-VM also contains a Spark-specific runtime agent executor for each tenant. The two elastic logic hosts 310-Y and 310-S are both allocated on the same physical host 300-H1. The two workload schedulers 115 and their specific runtime agents can work together, respectively to schedule and run their jobs and tasks securely isolated inside their respective VMs or hypervisor-based containers for different tenants as if the elastic logic hosts 310-Y and 310-S were traditional “physical hosts”.

Referring to FIG. 4B, once the Spark workload scheduler detects that the workloads for three of its tenants A (1, 2), tenant B (1, 2) and tenant F (8, 16) in three Kata container Lite-VMs has finished, the Spark workload scheduler releases a portion (10, 20) of its resource allocations 120s of the three Kata container Lite-VMs in its elastic logic host 310-S back to the resource scheduler 215, and uses its remaining resource allocations 120 of (6, 12) on elastic logic host 310-S for its remaining three Kata container Lite-VMs to run the remaining workloads for the three remaining tenants C, D, E.

The resource scheduler 215 schedules a new (8, 16) allocation, out of the newly released idle resources of (10, 20) released by the Spark workload scheduler and offers the new (8, 16) allocation to the YARN workload scheduler to fuse with its existing resource allocation 120y on its elastic logic host 310-Y on physical host 300-H1 to become (40, 80) resource allocation. The YARN workload scheduler accepts the offer, and schedules a new (8, 16) VM for tenant Z that already has a (16, 32) VM in the YARN workload scheduler elastic logic host 310-Y on physical host 300-H1.

Referring to FIG. 4C, once the YARN workload scheduler determines that its tenants X and Y have finished their workloads in elastic logic host 310-Y on physical host 300-H1, the YARN workload scheduler may advantageously stop all the existing small VMs other than the (16, 32) VM for tenant Z, and combine the resource allocation 120y to create a larger VM for tenant Z. workload scheduler-Y then may resize the (16, 32) VM (with or without restarting the VM depending on what vertical scaling techniques are used) into a larger (40, 80) VM for tenant Z. Now, since only one YARN-specific runtime agent node manager is required to run in each VM, the resources saved from the fewer number of node manager can be used for jobs and tasks in YARN.

In this example, the YARN workload scheduler and Spark workload scheduler are able to request and release resource allocations 120y, 120 s from/to the resource scheduler 215 and get available resource capacities on their respective elastic logic hosts 310-Y and 310-S that can be dynamically modified. If a VM or hypervisor-based container is resized without restarting, the workload schedulers 115 can synchronize the capacity changes with their specific runtime agents (YARN node manager or Spark executor inside the VM or hypervisor-based container) of the workload scheduling eco-systems. Then the workload schedulers 115 may schedule and run YARN workloads and Spark workloads respectively in their own elastic logic hosts 310-Y and 310-S on shared physical host 300-H1, based on their own business logics and workload scheduling policies.

This leaves the resource scheduler 215 free to focus on resource scheduling without having to consider workload details. The resource scheduler 215 can guarantee the elastic logic hosts of different workload schedulers 115 do not overlap or overuse resources when using the elastic logic host resources on the same physical host. The resource scheduler 215 is able to schedule the resources of elastic logic hosts, scaling them vertically up or down dynamically based on demands and resource availabilities on the physical hosts 300, in addition to scaling horizontally out or in by adding or reducing more physical hosts 300 and thereafter elastic logic hosts 310 for a workload scheduler 115.

The local resource managers and workload scheduler agents can execute workloads inside VMs and hypervisor-based containers as instructed by the workload schedulers 115 to ensure resource usages of the workloads will not go beyond the allocated resource capacities of the elastic logic host for their workload scheduler 115. Since the resource scheduler 215 guarantees that the total allocated resource capacities for all the elastic logic hosts of the workload schedulers 115 on a physical host 300 will neither overlap nor overuse resources, nor go beyond the underlying physical host resource capacity, the local resource managers can enforce such guarantees with the workload scheduler agents on the physical host 300.

The features of the herein disclosed method of cooperative scheduling of resources effectively decouples the resource scheduling by the resource scheduler 215, from the workload scheduling by the workload schedulers 115, and workload execution by the local resource managers and workload scheduler agents.

One advantage of the herein disclosed cooperative scheduling of computing resources is the coordination of all resource allocation plans 117 within and between the time windows specified in the resource allocation plans 117. This increases resource usage flexibility and efficiency for all workloads and makes large resource allocations easier to satisfy. Continuous scheduling of resource allocations and the use of elastic logic hosts facilitates the growth of small resource allocations into large resource allocations over time as needed.

Another advantage is cross-host fusion and scheduling optimization of resource allocations. Resource allocations can be organized, re-organized and consolidated for greater user satisfaction on a large scale. The resource scheduler is able to move or swap resource allocations from one physical host to fuse into resource allocations on another physical host when the second physical host has freed up sufficient resources. This can incrementally generate large resource allocations, which are often difficult to create. Moreover, resource affinity is improved by fusing multiple resource allocations from different physical hosts into one large allocation on the same physical host.

A further advantage is the use of elastic logic hosts to speed up on-boarding existing workload schedulers on a shared resource layer to run VMs and hypervisor-based containers on shared physical hosts to increase resource utilization. Multiple workload schedulers (such as batch, Big Data, HPC, Kubernetes controllers) can request resource allocations and elastic logic hosts from a resource scheduler in a shared resource layer. The workload schedulers can then use the elastic logic hosts as if they were physical hosts, effectively decoupling resource scheduling from workload scheduling. This makes it easier for the workload schedulers to securely schedule, isolate and run workloads of VMs and hypervisor-based containers on the same shared physical host with other workload schedulers. This can save engineering efforts and still allow them to continue evolving in their eco-systems of the workload schedulers, their runtime agents and other components that integrate and work together to run applications in distributed environments.

Yet another advantage is that a workload scheduler can partially release unused resources from its resource allocations back to the resource scheduler so that the resource scheduler can fuse the free resources into larger resource allocations for other workload schedulers and reduce fragmentation of resources. Workload schedulers can release a portion, or all of their resource allocations and elastic logic hosts back to the resource scheduler if the resources are no longer needed. The workload schedulers can release all of the resource allocations in a resource allocation plan, or only some of the resource allocations, or even fractions of an allocation. Resources released by the workload schedulers can be collected by the resource scheduler and fused into larger resource allocations.

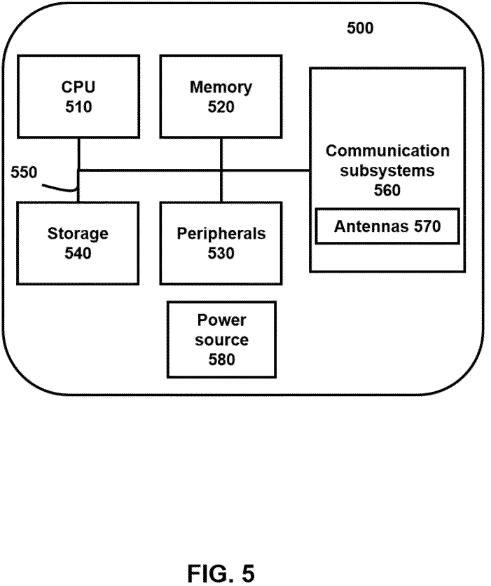

The above functionality may be implemented on any one or combination of computing devices. FIG. 5 is a block diagram of a computing device 500 that may be used for implementing the methods and apparatus disclosed herein. Device 500 may be representative of both a workload scheduler and a resource scheduler, according to at least some embodiments of the present disclosure. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 500 may comprise a central processing unit (CPU) 510, memory 520, a mass storage device 540, and peripherals 530. Peripherals 530 may comprise, amongst others one or more input/output devices, such as a speaker, microphone, mouse, touchscreen, keypad, keyboard, printer, display, network interfaces, and the like. Communications between CPU 510, memory 530, mass storage device 540, and peripherals 530 may occur through one or more buses 550.

The bus 550 may be one or more of any type of several bus architectures including a memory bus or memory controller, a peripheral bus, video bus, or the like. The CPU 510 may comprise any type of electronic data processor. The memory 520 may comprise any type of system memory such as static random-access memory (SRAM), dynamic random-access memory (DRAM), synchronous DRAM (SDRAM), read-only memory (ROM), a combination thereof, or the like. In an embodiment, the memory 520 may include ROM for use at boot-up, and DRAM for program and data storage for use while executing programs.

The mass storage device 540 may comprise any type of storage device configured to store data, programs, and other information and to make the data, programs, and other information accessible via the bus. The mass storage device 540 may comprise, for example, one or more of a solid-state drive, hard disk drive, a magnetic disk drive, an optical disk drive, or the like.

The computing device 500 may also include one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network, for data processing and communications with remote devices, such as other processing units, the Internet, remote storage facilities, or the like.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, apparatuses, and or devices are not intended to be limited to the embodiments disclosed herein. The scope of the claims should not be limited by these embodiments but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

1. A method for scheduling computing resources, the method comprising:
submitting a resource allocation plan by a workload scheduler to a resource scheduler;
allocating by the resource scheduler a first resource allocation of first resources in accordance with the resource allocation plan and notifying the workload scheduler of the first resource allocation;
running workloads of the workload scheduler on the first resources by the workload scheduler;
allocating by the resource scheduler a second resource allocation of second resources in accordance with the resource allocation plan and notifying the workload scheduler of the second resource allocation; and
running the workloads of the workload scheduler on the second resources by the workload scheduler.

2. The method of claim 1, wherein the resource allocation plan includes at least one allocation plan attribute chosen from a group of attributes consisting of allocation specifications, allocation goals, scheduling hints, and time constraints.

3. The method of claim 1, wherein the resource allocation plan includes a request for fusible resources, the method further comprising fusing by the resource scheduler at least a portion of the first resource allocation with at least a portion of the second resource allocation.

4. The method of claim 1, further comprising releasing at least a portion of the first resource allocation or at least a portion of the second resource allocation by the workload scheduler back to the resource scheduler when the at least a portion of the first resource allocation or the at least a portion of the second resource allocation is no longer required to run the workloads of the workload scheduler.

5. The method of claim 1, further comprising offering by the resource scheduler to the workload scheduler a third resource allocation when the resource allocation plan has not been completed and the resource scheduler has additional resources to allocate in accordance with the resource allocation plan.

6. The method of claim 5, wherein the resource allocation plan includes a request for fusible resources, the method further comprising:
accepting the third resource allocation by the workload scheduler; and
fusing by the resource scheduler at least a portion of the third resource allocation with at least a portion of the first resource allocation or at least a portion the second resource allocation.

7. The method of claim 1, further comprising, modifying the resource allocation plan by the workload scheduler or submitting a new resource allocation plan by the workload scheduler to the resource scheduler.

8. The method of claim 1, wherein the workload scheduler is a first workload scheduler and the resource allocation plan is a first resource allocation plan, the method further comprising:
submitting a second resource allocation plan by a second workload scheduler to the resource scheduler to run workloads of the second workload scheduler.

9. An apparatus comprising:
a workload scheduler comprising a processor having programmed instructions to prepare and submit a resource allocation plan to a resource scheduler;
the resource scheduler comprising a processor having programmed instructions to receive the resource allocation plan from the workload scheduler and allocate a first resource allocation of first resources in accordance with the resource allocation plan and to notify the workload scheduler of the first resource allocation;
the processor of the workload scheduler is configured to run workloads of the workload scheduler on the first resources;
the processor of the resource scheduler is configured to allocate a second resource allocation of second resources in accordance with the resource allocation plan and notify the workload scheduler of the second resource allocation; and
the processor of the workload scheduler is configured to run the workloads of the workload scheduler on the second resources.

10. The apparatus of claim 9, wherein the resource allocation plan includes at least one allocation plan attribute chosen from a group of attributes consisting of allocation specifications, allocation goals, scheduling hints, and time constraints.

11. The apparatus of claim 9, wherein:
the resource allocation plan includes a request for fusible resources, and
the processor of the resource scheduler is configured to fuse at least a portion of the first resource allocation with at least a portion of the second resource allocation.

12. The apparatus of claim 9, wherein the processor of the workload scheduler is configured to release at least a portion of the first resource allocation or at least a portion of the second resource allocation back to the resource scheduler when the at least a portion of the first resource allocation or the at least a portion of the second resource allocation is no longer required to run the workloads of the workload scheduler.

13. The apparatus of claim 9, wherein:
the processor of the resource scheduler is configured to offer to the workload scheduler a third resource allocation when the resource allocation plan has not been completed, and
the resource scheduler has additional resources to allocate in accordance with the resource allocation plan.

14. The apparatus of claim 13, wherein:
the resource allocation plan includes a request for fusible resources,
the processor of the workload schedule is configured to accept the third resource allocation, and
the processor of the resource scheduler is configured to fuse at least a portion of the third resource allocation with at least a portion of the first resource allocation or at least a portion the second resource allocation.

15. The apparatus of claim 9, wherein the processor of the workload scheduler is configured to modify the resource allocation plan or submit a new resource allocation plan to the resource scheduler.

16. The apparatus of claim 9, wherein the workload scheduler is a first workload scheduler and the resource allocation plan is a first resource allocation plan, the apparatus further comprising:
a second workload scheduler comprising a processor having programmed instructions to prepare and submit a second resource allocation plan to the resource scheduler to run workloads of the second workload scheduler.

17. (canceled)

18. A non-transitory computer-readable medium comprising instructions which, when executed by a computer, cause the computer to carry out a method of scheduling computing resources, the method comprising:
submitting a resource allocation plan by a workload scheduler to a resource scheduler;
allocating by the resource scheduler a first resource allocation of first resources in accordance with the resource allocation plan and notifying the workload scheduler of the first resource allocation;
running workloads of the workload scheduler on the first resources by the workload scheduler;
allocating by the resource scheduler a second resource allocation of second resources in accordance with the resource allocation plan and notifying the workload scheduler of the second resource allocation; and
running the workloads of the workload scheduler on the second resources by the workload scheduler.

19. The non-transitory computer-readable medium of claim 18, wherein the resource allocation plan includes at least one allocation plan attribute chosen from a group of attributes consisting of allocation specifications, allocation goals, scheduling hints, and time constraints.

20. The non-transitory computer-readable medium of claim 18, wherein the resource allocation plan includes a request for fusible resources, the method further comprising fusing by the resource scheduler at least a portion of the first resource allocation with at least a portion of the second resource allocation.

21. The non-transitory computer-readable medium of claim 18, wherein the method further comprises releasing at least a portion of the first resource allocation or at least a portion of the second resource allocation by the workload scheduler back to the resource scheduler when the at least a portion of the first resource allocation or the at least a portion of the second resource allocation is no longer required to run the workloads of the workload scheduler.
